(19) United States
(12) Patent Application Publication
(10) Pub. No.: US 2012/0139215 A1
(43) Pub. Date: Jun. 7, 2012

(54) SIDE GAS BAG ARRANGEMENTS FOR A VEHICLE OCCUPANT RESTRAINT SYSTEM

(75) Inventors: Rainer HEUSCHMID, Ulm (DE); Delphine Bello, Langenau (DE); Johannes Baumhauer, Sussen (DE); Armin Kircher, Weissenhorn (DE); Stefan Wiegert, Ulm (DE); Alexander Siebert, Ulm (DE); Thomas Pletl, Langenau (DE); Manfred Schmid, Illertissen (DE)

(73) Assignee: TAKATA-PETRI AG

(21) Appl. No.: 13/310,364

(22) Filed: Dec. 2, 2011

(30) Foreign Application Priority Data
Dec. 3, 2010 (DE) 10 2010 062 422.5

(51) Int. Cl. B60R 21/16

(52) U.S. Cl. 280/730.2

(57) ABSTRACT

A side gas bag arrangement for a vehicle occupant restraint system of a motor vehicle is provided. The side gas bag arrangement comprising at least one side gas bag inflatable for the protection of a vehicle occupant, which with a side gas bag arrangement mounted in the vehicle and in the inflated condition of the side gas bag extends along a long side of the vehicle, wherein the side gas bag includes at least one inflatable chamber which is formed such that in the inflated condition of the side gas bag it extends over a side window of the vehicle and in direction of the vehicle floor beyond a door sill adjoining the side window; and sealing means which at least seal a partial region of the side gas bag, so that gas is prevented from flowing out of this partial region to the outside.

### CROSS-REFERENCE TO RELATED APPLICATION

This application claims the benefit of the German Patent Application No. 10 2010 062 422.5 filed Dec. 3, 2010, the disclosure of which is fully incorporated herein by reference.

### BACKGROUND OF THE INVENTION

This invention relates to a side gas bag arrangement for a vehicle occupant restraint system of a motor vehicle.

From the prior art, side gas bags are known which after activation extend along a long side of a vehicle and in particular serve to protect the head of at least one vehicle occupant (“curtain gas bags” or “head protection side gas bags”). For example, the U.S. Pat. No. 6,237,939 B1 discloses such side gas bag.

### SUMMARY OF THE INVENTION

The problem to be solved by the present invention consists in creating a side gas bag arrangement whose side gas bag prevents a vehicle occupant from moving out of the vehicle as well as possible over a period as long as possible after its activation.

According to an exemplary embodiment of the invention there is provided a side gas bag arrangement for a vehicle occupant restraint system of a motor vehicle, comprising
at least one side gas bag inflatable for the protection of a vehicle occupant, which with the side gas bag arrangement mounted in the vehicle and in the inflated condition of the side gas bag extends along a long side of the vehicle, wherein
the side gas bag includes at least one inflatable chamber which is formed such that in the inflated condition of the side gas bag it extends over a side window of the vehicle and in direction of the vehicle floor beyond a door sill adjoining the side window; and
sealing means which at least seal a partial region of the side gas bag, so that gas is prevented from flowing out of this partial region to the outside.

The side gas bag in particular is a curtain gas bag for the protection of a head of the vehicle occupant, which in particular extends over several seat rows of the vehicle. For example, the gas bag can extend over two, but also over more than two seat rows. It is of course also conceivable that the side gas bag is designed such that it only extends over one seat row.

Due to the protection chamber prolonged downwards beyond the door sill, the inflated side gas bag is stabilized in its position, so that the gas bag is prevented as far as possible from being pressed out through a side window of the vehicle as a result of an impact of a vehicle occupant or of several vehicle occupants on the gas bag. Due to this stabilization of the side gas bag, the vehicle occupant(s) thus is(are) prevented as far as possible from moving out of the vehicle during an accident (“ejection mitigation”).

Beside the stabilization via the at least one chamber overlapping the door sill, a rather high tightness of at least a partial region of the side gas bag is ensured by means of the sealing means, so that at least this partial region has a rather long useful life and correspondingly contributes to the fact that in the course of an accident (in particular during swerving and/or rolling-over of the vehicle) the side gas bag is not pressed out from the vehicle interior and the vehicle occupant is retained in the vehicle as well and as long as possible.

In particular, the chamber protruding downwards beyond the door sill is correspondingly sealed by the sealing means. The side gas bag of course can include more than one chamber, which chambers extend downwards beyond the door sill and are also sealed by the sealing means. It is of course also conceivable that the entire side gas bag is sealed by the sealing means.

In accordance with one exemplary aspect of the invention, at least one inflatable chamber of the side gas bag, which in particular is the chamber extending beyond the door sill, is formed to extend obliquely to the vehicle height direction, i.e. the chamber extends along a main direction of extension which is oriented obliquely to the vehicle height direction (with respect to a side gas bag arrangement mounted in the vehicle and after inflating the gas bag). For example, this chamber includes an angle with the vehicle height direction between 5° and 45° (lower chamber end is inclined towards the vehicle front) or between −5° and −45° (lower chamber end is inclined away from the vehicle front).

It is also possible that the side gas bag includes a plurality of inflatable chambers for the protection of a vehicle occupant or a plurality of vehicle occupants, some of which extend obliquely and others parallel to the vehicle height direction. It is, however, also conceivable that all protection chambers of the gas bag extend obliquely to the vehicle height direction, wherein of course not each of the chambers must include the same angle with the vehicle height direction. It is also possible that none of the chambers of the side gas bag extends obliquely, but all chambers are oriented vertically, i.e. parallel to the vehicle height direction.

In particular, the side gas bag is formed of at least two gas bag layers (in particular in the form of fabric layers) which are connected with each other by a seam, wherein the seam is sealed by a sealing material of the sealing means. In particular, this seam is a peripheral seam which can be sealed partly or also at least approximately completely by the sealing material. The sealing material is e.g. an elastic material, for instance a material containing silicone.

In particular, a chamber of the side gas bag is sealed in that the seams defining the same are sealed by the sealing material. Alternatively or in addition to the sealing material an additional sealing seam can be provided, which extends along the seams to be sealed.

In addition, the sealing means can comprise a sealing coating which is arranged on an inner side of the sealed partial region of the side gas bag. In particular, the sealing coating extends on the inner sides of gas bag layers which form the side gas bag, wherein at least one or more chambers of the side gas bag are provided with the sealing coating on their respective inner side. As sealing coating, e.g. a silicone coating can be used.

In principle, it is also conceivable that the side gas bag is not formed from a gas bag material in the form of fabric layers, but e.g. from a film-like material which itself already has sufficiently gas-tight properties, so that arranging a sealing coating can be omitted.

The sealing means in particular are formed such that they seal at least the partial region of the side gas bag such that the internal pressure in the partial region (e.g. in the form of a chamber of the side gas bag) is maintained at a pressure of at least 0.2 bar in a period of about 1-2 s after activation of the side gas bag (i.e. after ignition of a gas generator provided for inflating the side gas bag). In addition, the side gas bag can be designed such that in the period of about 5.5 to 6.5 seconds after activation its internal pressure still is at least about 0.1 bar.

In accordance with another exemplary development of the invention, the protection chamber of the side gas bag extending beyond the door sill—as seen in longitudinal direction of the vehicle—is located in a middle region of a front side window or in a rear region of a rear side window of the vehicle, i.e. this chamber does not extend over the entire length of the side window—as seen in longitudinal direction of the vehicle—, but only covers a partial region of the respective side window.

As already mentioned above, the side gas bag in particular includes a plurality of inflatable chambers which in the inflated condition of the gas bag extend along a main direction of extension in direction of the vehicle floor, i.e. are elongated, thus have a length which is a multiple (e.g. at least three times) of the width (in longitudinal direction of the vehicle) of the chamber.

In addition, the side gas bag arrangement can include a plurality of fixing structures by which the side gas bag can be fixed on a vehicle structure, wherein the side gas bag is to be arranged in the vehicle such and the fixing structures are arranged such that they each lie on a common line with an impact region unambiguously specified in dependence on the size of the side window of the vehicle, which line extends parallel to the vehicle height direction.

The “impact point” (“hit location”) is a point of the vehicle side structure (of the side window) on which the vehicle occupant will impact during an accident with increased probability. The positions of such hit locations are unambiguously defined in corresponding legal provisions (cf. in particular the U.S. provision FMVSS 226), wherein the positions of the hit locations on the vehicle side structure are determined in dependence on the size of the side window observed.

Furthermore, the side gas bag arrangement according to the invention can include a plurality of fixing structures (e.g. in the form of fixing holes or fixing tabs) via which the side gas bag can be fixed on a vehicle structure (in particular the long side of the vehicle), wherein the fixing structures each are associated to at least one of the chambers of the side gas bag and are arranged in one line with the same. In this way, a rather good stabilization of the inflated gas bag should be achieved.

Of course, the side gas bag can include further fixing structures which do not lie in one line with one of the chambers of the gas bag. Via the fixing structures, the gas bag is connected with the long side structure of the vehicle in a non-positive, positive and/or cohesive manner, e.g. via fixing clips, screws, rivets, dowels, clamps, by bonding and/or welding. In the region of the fixing structures, the side gas bag in addition can include a fabric doubling or a reinforcing layer.

Furthermore, it can be provided that the side gas bag also can be connected with the vehicle body via a component of a gas generator which is provided for inflating the side gas bag. In particular, at least some of the fixing structures are formed such that a rather high (with respect to the vehicle height direction) fixation (bracing) of the side gas bag is possible, so that a rather large-surface coverage of the side window regions of the long side of the vehicle and/or a rather good overlap with an upper portion (facing a roof rail of the vehicle) of a frame of the side window is possible.

The side gas bag arrangement according to the invention also can include a side gas bag with at least one inflatable stabilizing chamber, wherein the stabilizing chamber primarily should prevent a vehicle occupant from moving out of the vehicle. This means that the stabilizing chamber does not necessarily serve to prevent an impact of the vehicle occupant on the vehicle side structure or to cushion an impact, but chiefly serves to as far as possible prevent the side gas bag and hence the vehicle occupant from moving out of a side window in the course of an accident.

For example, such stabilizing chamber—as seen in driving direction—is located before the first actual protection chamber of the gas bag. In other words, the side gas bag includes at least one stabilizing chamber and a plurality of protection chambers, wherein the protection chambers other than the stabilizing chamber primarily are formed for protection (i.e. for cushioning an impact of a vehicle occupant) and after inflating the gas bag correspondingly are positioned in a region in which a vehicle occupant would impact in most cases in an accident (in particular in a side collision), for example laterally beside a vehicle seat. It is also conceivable that a plurality of stabilizing chambers are provided, wherein of course not necessarily all stabilizing chambers must be located before the protection chambers. Rather, stabilizing chambers can also be arranged between protection chambers and/or behind the protection chambers.

The side gas bag arrangement according to the invention also can include throttling means, which serve for throttling an inflow of gas into the stabilizing chamber. By means of the throttling means it should be avoided that in the starting phase of inflating the gas bag too much gas flows into the stabilizing chamber, which would no longer be available for inflating the protection chambers. By means of the throttling means it thus is achieved that after igniting the gas generator the protection chambers initially are filled as fast as possible, so that their protective function is not impaired by the presence of the at least one additional stabilizing chamber. For example, the throttling means are formed such that the stabilizing chamber only is filled completely after about 0.5 seconds after activating the gas generator.

For example, the throttling means comprise an opening or a channel of the side gas bag, which has a smaller flow cross-section than an upstream portion of the side gas bag adjoining the opening or the channel. Here, it is conceivable that the side gas bag is formed by two gas bag layers connected with each other via a circumferential connecting line and the opening or the channel extends between a portion of the connecting line and a further connecting region or between two connecting regions spaced from the circumferential connecting line.

For example, the circumferential connecting line is a peripheral seam (sewn seam) which has already been mentioned above. It is, however also conceivable that the gas bag layers are bonded or welded along the connecting line. Correspondingly, the connecting region can be a sewn seam or a region in which the gas bag layers are bonded or welded to each other.

There can also be provided a channel (i.e. a spatial formation) which likewise is defined e.g. by darts and/or seams, by which two gas bag layers of the side gas bag are connected with each other. For example such channel is formed tubular, helical or conical, i.e. with a tapering cross-section. It is also conceivable that the channel is arranged such that an overflow is effected in dependence on a pressure difference between the internal pressure in the stabilizing chamber and an internal pressure in a partial region of the gas bag which adjoins the stabilizing chamber via the channel.

Furthermore, the throttling means can form a check valve which acts against gas flowing back out of the stabilizing chamber, in order to achieve a useful life of the stabilizing chamber as long as possible. In particular, as already described above, the stabilizing chamber can be sealed via the sealing means of the side gas bag arrangement.

In accordance with another exemplary embodiment of the invention, a catch element is provided for stabilizing the inflated side gas bag, which with one end is fixed on a connecting region of the side gas bag. The connecting region is positioned such that in the inflated gas bag it has a distance to an edge of the side gas bag. For example, the other end of the catch element is connected with the long side of the vehicle behind the side gas bag—as seen in longitudinal direction of the vehicle—, and the connecting region is located at a distance to a portion of the gas bag edge pointing to the rear of the vehicle. In particular, the catch element is formed as a catch strap (e.g. consisting of a fabric material). Furthermore, it is conceivable that additionally or alternatively there is also provided at least one catch element which connects a front side of the side gas bag with a front region of the long side structure of the vehicle, in particular analogous to the rear-side catch element described above.

It is, however, also conceivable that the catch element has another geometry, e.g. is formed like a sail, i.e. has a flat, e.g. at least approximately triangular plan, wherein one corner of the sail is connected with the vehicle body and one side is connected with the side gas bag.

Furthermore, it is conceivable that more than two catch elements are provided, e.g. a plurality of catch straps, which in particular with one end are fixed on a common connecting region of the vehicle body and diverge in direction of the vehicle front.

In addition, it is also possible that the catch element extends through at least one opening in the side gas bag. For example, the opening is located in a gas bag layer of the side gas bag, so that the catch element extends into the interior of the gas bag and e.g. is connected there with an inner side of the gas bag layer. It is, however, also conceivable that the opening is a through opening which extends e.g. through all gas bag layers of the side gas bag, so that the catch element enters into the opening on one side of the side gas bag and again exits on the other side of the side gas bag. This opening in particular is formed as an eyelet and defined e.g. by a ring.

In accordance with another exemplary variant of the invention the side gas bag has a plurality of openings through which the catch element passes such that in the inflated condition of the side gas bag it alternately extends on a side of the side gas bag facing the long side of the vehicle and on a side of the side gas bag facing the vehicle interior.

In another exemplary aspect of the invention the side gas bag is folded and/or rolled up along a direction which extends obliquely to its main deployment direction. With respect to the condition of the side gas bag arrangement mounted in the vehicle, the “main deployment direction” of the side gas bag in particular extends parallel to the vehicle height direction. The direction of rolling up or folding is that direction which is oriented vertical to an axis about which the side gas bag is rolled up and/or vertical to a folding line. For example, the rolling or folding direction includes an angle between about 10° and 60° or between about 10° and 30° with the main deployment direction.

The folded side gas bag in particular is arranged longitudinally extended along a roof frame of the vehicle and after activation unfolds towards the vehicle floor, i.e. along the vehicle height direction. When the seams are sealed, the described oblique folding of the side gas bag in particular can serve to avoid that the sealing seams overlap along a greater length, so that beads rather are avoided and a gas bag folded as compact as possible is obtained.

The side gas bag of the side gas bag arrangement according to the invention is of course not limited to a certain kind of folding. For example, the gas bag can be rolled (inwards and/or outwards), zigzag-folded, turned over, folded down and/or turned inside out. In particular, the gas bag can also be compacted by a combination of these measures, for example to achieve a rather uniform deployment and/or to achieve a deployment of various gas bag regions at different times.

In another example of the invention, the side gas bag of the side gas bag arrangement is formed of at least one fabric layer which includes a plurality of first threads (warp threads) and a plurality of second threads (weft threads) which extend vertical to the first threads, wherein the gas bag is arranged in the vehicle such that the first or second threads—with respect to the condition of the side gas bag mounted in the vehicle and inflated—at least partly extend substantially parallel to a roof frame (roof rail) of the vehicle. It is also conceivable that the first or the second threads extend parallel to the above-mentioned fixing structures of the gas bag.

In another exemplary variant of the invention the first and second threads of the fabric layers at least partly extend under an angle of at least 10° with the roof frame. It should be noted that the side gas bag can also be formed of a plurality of fabric layers (e.g. two, as already mentioned above), which need not necessarily be identical. Rather, it is conceivable that different fabrics are used.

In accordance with a further exemplary embodiment of the invention a side gas bag arrangement, in particular as described above, is provided, comprising
at least one side gas bag inflatable for the protection of a vehicle occupant, which with a side gas bag arrangement mounted in the vehicle and in the inflated condition of the side gas bag extends along a long side of the vehicle, wherein
the side gas bag includes at least one inflatable chamber which in the inflated condition of the side gas bag extends obliquely to the vehicle height direction; and
sealing means which at least seal a partial region of the side gas bag, so that gas is prevented from flowing out of this partial region to the outside.

According to this aspect of the invention, the gas bag does not necessarily include a chamber which overlaps with the door sill of the vehicle. Rather, all chambers of the side gas bag can be designed such that they do not extend beyond the door sill, wherein at least one of the chambers, however, extends obliquely relative to the vehicle height direction. Of course, the gas bag can, however, also include at least one chamber overlapping with the door sill.

As already mentioned above, the wording that “the chamber” extends obliquely to the vehicle height direction refers to the main extension direction of the chamber, which is oriented obliquely to the vehicle height direction. For example, the main extension direction of the chamber includes an angle with the vehicle height direction between 5° and 45° (lower chamber end is inclined towards the vehicle front) or between −5° and −45° (lower chamber end is inclined away from the vehicle front).

The invention also relates to a vehicle with a side gas bag arrangement according to any of the variants explained above.

### BRIEF DESCRIPTION OF THE DRAWINGS

The invention will subsequently be explained in detail by means of exemplary embodiments with reference to the Figures, in which:

FIG. 1 shows a side gas bag arrangement according to an exemplary embodiment of the invention.

FIG. 2 shows a modification of the exemplary embodiment of FIG. 1.

FIG. 3 shows a further modification of the exemplary embodiment of FIG. 1.

FIG. 4A shows a section of a side gas bag arrangement according to the invention.

FIG. 4B shows a modification of FIG. 4A.

FIG. 5A shows a further modification of FIG. 1.

FIG. 5B schematically shows a section from FIG. 5A.

FIG. 6A shows a side gas bag arrangement according to a further exemplary embodiment of the invention.

FIGS. 6B-6D show different variants of the side gas bag arrangement of FIG. 6A.

FIG. 7A shows an example of a folding of a side gas bag of a gas bag arrangement according to the invention.

FIG. 7B shows a section through the rolled and folded gas bag of FIG. 7A

FIGS. 8A to 8G show different foldings/rollings of a side gas bag of a side gas bag arrangement according to the invention.

FIG. 9A shows a section of a side gas bag arrangement according to further exemplary embodiments of the invention.

FIG. 9B shows a modification of the exemplary embodiment of FIG. 9A.

FIG. 10 shows a side gas bag arrangement according to the second aspect of the invention.

### DETAILED DESCRIPTION

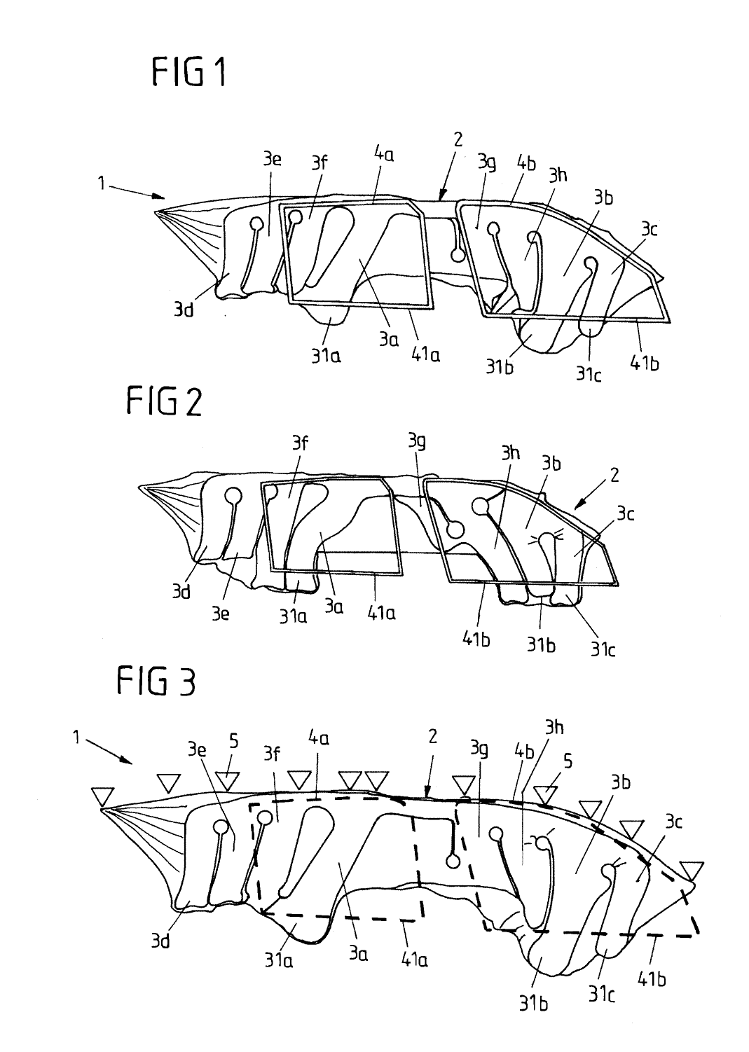

The side gas bag arrangement 1 according to the invention as shown in FIG. 1 comprises a side gas bag in the form of a curtain gas bag 2 which includes a plurality of chambers 3a, 3b, 3c which in the inflated condition of the side gas bag 2 (and with the side gas bag arrangement mounted in the vehicle) extend beyond a side window 4a, 4b and beyond a portion 41a, 41b of the door sill of the vehicle towards the vehicle floor, wherein a portion 31a to 31c of the respective chamber each extends beyond the door sill. The door sill is formed by an edge of the lateral vehicle body, which defines the side windows 4a, 4b at the bottom (i.e. on a side facing the vehicle floor).

Beside the chambers 3a to 3c protruding beyond the door sill, the curtain gas bag 2 includes further chambers 3d to 3h, some of which (the chambers 3d-f) are located in the rear region (facing the vehicle rear) of the side gas bag and in particular are associated to a rear bench of the vehicle. Like the overlapping chamber 3, however, the further chambers 3g and 3h are associated to a front seat (the driver seat or the front-passenger seat) of the vehicle.

In the present example, all chambers 3a to 3h of the gas bag 2 extend obliquely with respect to the vehicle height direction (i.e. obliquely to the main deployment direction of the gas bag), wherein the chambers are inclined at different angles relative to the vehicle height direction.

It should be noted that the front chamber 3c chiefly serves to prevent the gas bag and a vehicle occupant from being pressed out of the side windows 4a, 4b in the course of an accident, i.e. the front chamber 3c is a stabilizing chamber. The chamber 3f arranged in the rear region also has a similar function. In contrast to the stabilizing chambers 3c and 3f, the remaining chambers of the gas bag 2 chiefly serve as protection chambers, i.e. they should cushion an impact of one or more vehicle occupants onto the vehicle side structure and absorb as much impact energy as possible during the impact. For example, the protection chambers include an outflow opening, but the stabilizing chambers do not.

FIG. 2 shows an alternative design of a gas bag of the side gas bag arrangement according to the invention. Here, the front stabilizing chamber 3c substantially extends parallel to the vehicle height direction (i.e. it is aligned substantially vertically). Furthermore, some of the chambers (the rear protection chamber 3a and the rear stabilizing chamber 3f) have a curvature, so that in their upper region (facing the roof rail) they extend at an angle to the vehicle height direction, but in their lower region they have a portion extending almost parallel to the vehicle height direction, which overlaps with the door sill 41a.

FIG. 3 relates to another development of the side gas bag 2 from FIG. 1, according to which an edge of the gas bag 2 facing the roof rail (not shown) of the vehicle includes a plurality of fixing structures 5, by means of which the gas bag 2 can be fixed on a vehicle side structure (not shown). For example, the fixing structures 5 are fixing tabs and/or fixing holes.

The fixing structures 5 now are at least partly arranged such that they each are associated to one of the chambers 3a to 3h, wherein they are positioned such that they substantially are located in one line with the chamber, i.e. they are substantially not arranged between the chambers, in order to be able to realize a fixation (bracing) of the side gas bag as stable as possible.

The side gas bags shown in FIGS. 1 to 3 are made of at least two fabric layers which are connected with each other by various seams, wherein some of the seams define the chambers 3a to 3f. To be able to maintain the pressure in at least some of the chambers 3a to 3h as long as possible, at least some of the chambers are sealed by sealing means, so that gas is prevented from flowing out of the corresponding chamber via the gas bag material and/or via a seam defining the chamber.

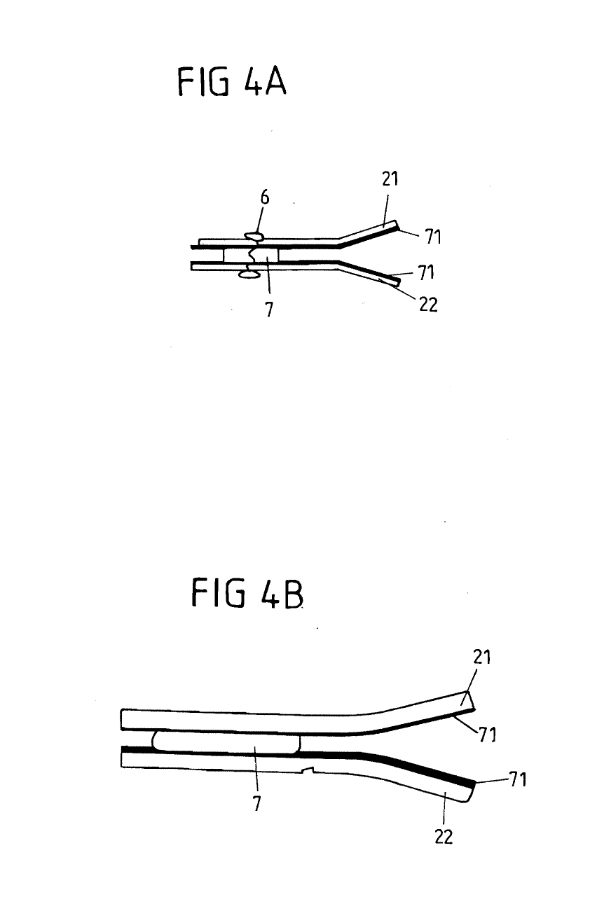

For example, the seams or at least some of the seams or portions of the seams of the side gas bag 2 are sealed by a sealing material 7, as shown in FIG. 4A. Here, a seam 6 connects a first fabric layer 21 with a second fabric layer 22 of the side gas bag, wherein the seam 6 is embedded in a (e.g. silicone-containing) sealing material 7. Moreover, the fabric layers 21, 22 each have a sealing coating (e.g. a silicone coating) 71 on their inner side, in order to prevent an outflow through the fabric material 21, 22 as far as possible.

It is also conceivable that an inflatable region (e.g. a chamber) of the side gas bag 2 is not defined by a sewn seam, but only by a bonded or a welded seam, as is shown in FIG. 4B.

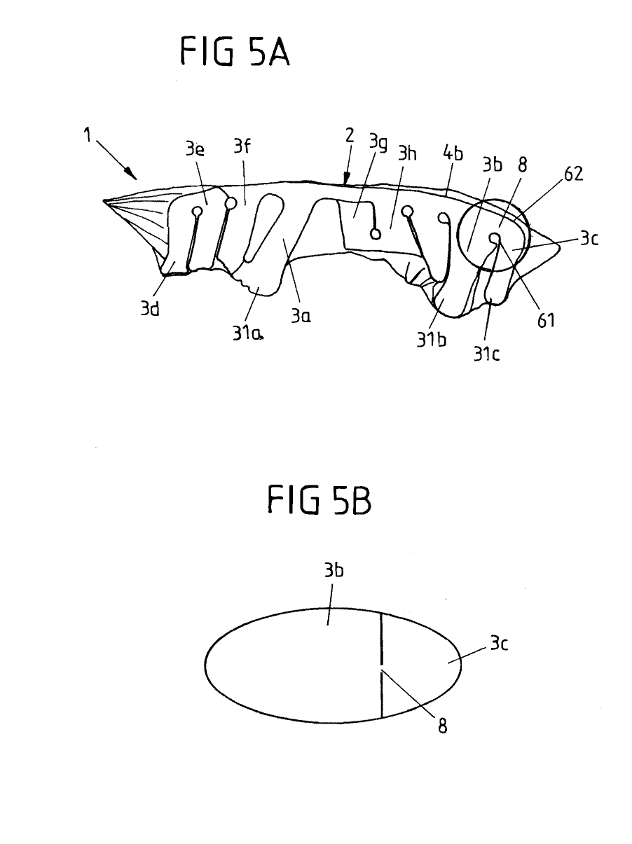

FIGS. 5A and 5B relate to a further modification of the side gas bag arrangement 1 described above. Accordingly, the side gas bag 2 of the side gas bag arrangement includes throttling means in the form of an overflow channel 8, via which a flow connection exists between the front stabilizing chamber 3c and the adjoining protection chamber 3b.

The overflow channel 8 on the one hand is formed by a substantially circular dart 61 and by a portion 62 of a peripheral seam 60 of the gas bag 2 such that its flow cross-section is smaller than a flow cross-section of the side gas bag 2 upstream before the channel 8, i.e. in the region of the protection chamber 3b. In this way, a gas stream into the front stabilizing chamber 3c is throttled, so as not to impair a rather fast inflation of the protection chambers of the side gas bag due to the presence of the stabilizing chamber 3c. The front stabilizing chamber 3c only is filled completely some time (about 0.5 seconds) after the activation of the side gas bag 2. Similarly, the rear stabilizing chamber 3f also can be connected with at least one of the adjacent protection chambers via a throttling channel. The throttling effect by the channel 8 also is schematically shown once again in FIG. 5B. Beside the throttling function, the channel 8 also can form a check valve which prevents gas from flowing out of the stabilizing chamber 3c.

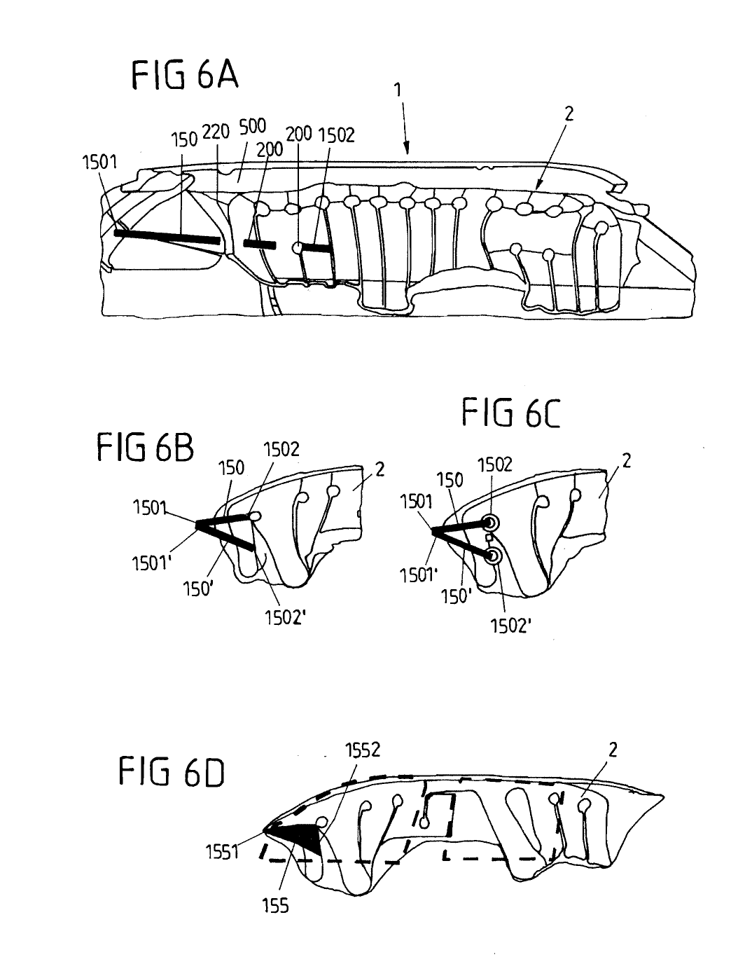

FIG. 6A shows a further variant of a side gas bag of a side gas bag arrangement according to the invention, wherein almost all gas bag chambers in the inflated gas bag at least approximately extend substantially parallel to the vehicle height direction.

In addition, the side gas bag arrangement includes a catch element in the form of a catch strap 150 which with a rear end 1501 is fixed in the rear region of the vehicle side structure 500. Furthermore, the catch strap 150 is guided through a plurality of openings 200 in the gas bag 2 such that it partly extends on a side of the side gas bag facing the vehicle side structure 500 and on a side facing away from the vehicle side structure. The end 1502 of the catch strap 150 facing away from the end 1501 fixed on the vehicle is attached (e.g. sewn) to the gas bag 2 with a distance to a rear edge 220 of the gas bag, which points to the vehicle rear. The end 1502 can be connected with an outer side of the gas bag or also be located in the interior of a chamber of the side gas bag and be connected with an inner side of the side gas bag.

The distance between the fixing region of the gas bag, on which the end 1502 of the catch strap is fixed, and the edge 220 in particular is dimensioned such that between the edge and the end 1502 at least one chamber of the gas bag is located.

It is also conceivable that the catch strap 150 is guided through a through opening provided in the gas bag at a distance to the rear lateral edge of the side gas bag 2 and the second end 1502 likewise is connected with the vehicle side structure 500 in the region of its first end 1501. Furthermore, it is also conceivable that more than one catch strap is provided, as shown in FIGS. 6B and 6C.

Here, an end 1501, 1501′ of two catch straps 150, 151 each is connected with the vehicle side structure, while the respective other end 1502, 1502′ is fixed on the side gas bag, likewise with a distance to the rear edge of the side gas bag. As mentioned already, fixing the catch strap need not be effected on the outer side of the side gas bag, but the end 1502, 1502′ rather can also be guided into the gas bag via a through opening defined e.g. by a ring and can be connected with an inner side of the gas bag.

Instead of an elongated strap, a material element with another geometry can also be used as catch element, for example a sail of a fabric material substantially triangular in a top view, as shown in FIG. 6D. Here the fabric sail 155 is fixed on the vehicle side structure with one corner 1551 and on the side gas bag 2 with a side 1552 opposite the corner.

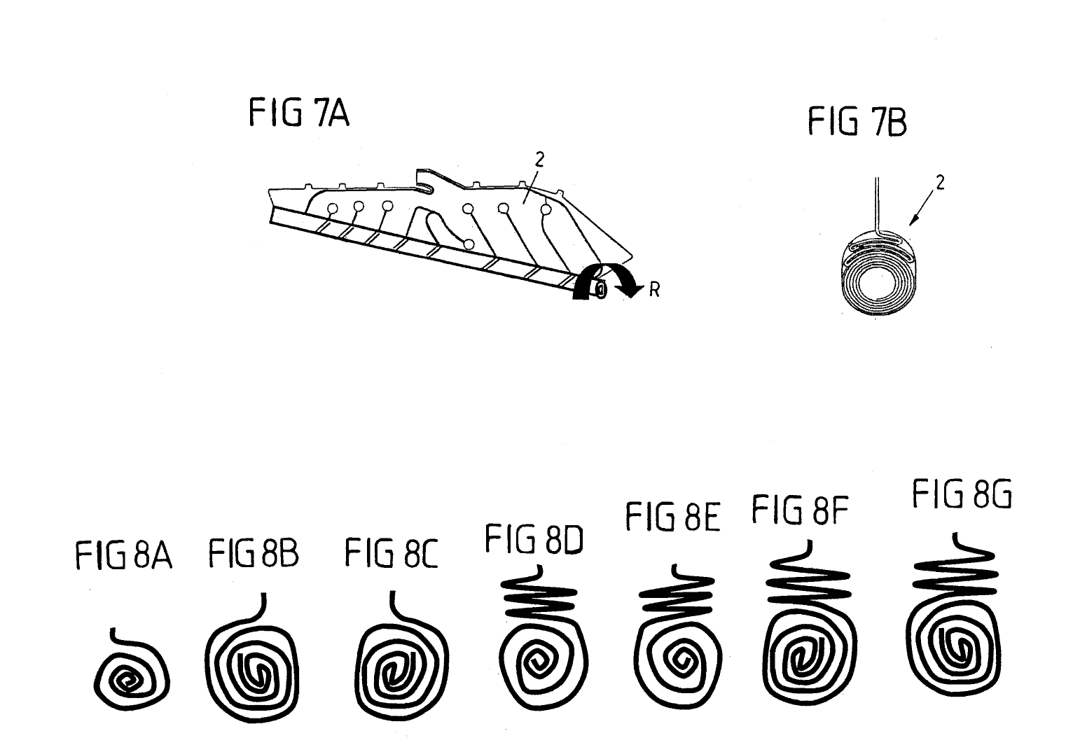

FIGS. 7A and 7B illustrate a possible variant for folding or rolling the side gas bag of the side gas bag arrangement according to the invention. Here, the gas bag is at least partly rolled up along a direction which extends obliquely to the main deployment direction of the side gas bag, i.e. the axis about which the gas bag is rolled up, and the folding line (or the plurality of folding lines) extends obliquely to the main deployment direction of the gas bag.

The gas bag need not be rolled up continuously, but there can also be used a combination of rolling and folding. Examples are shown in FIG. 7B (section through the rolled and folded gas bag of FIG. 7A) and in the sectional views of the compacted side gas bag of FIGS. 8A to 8G.

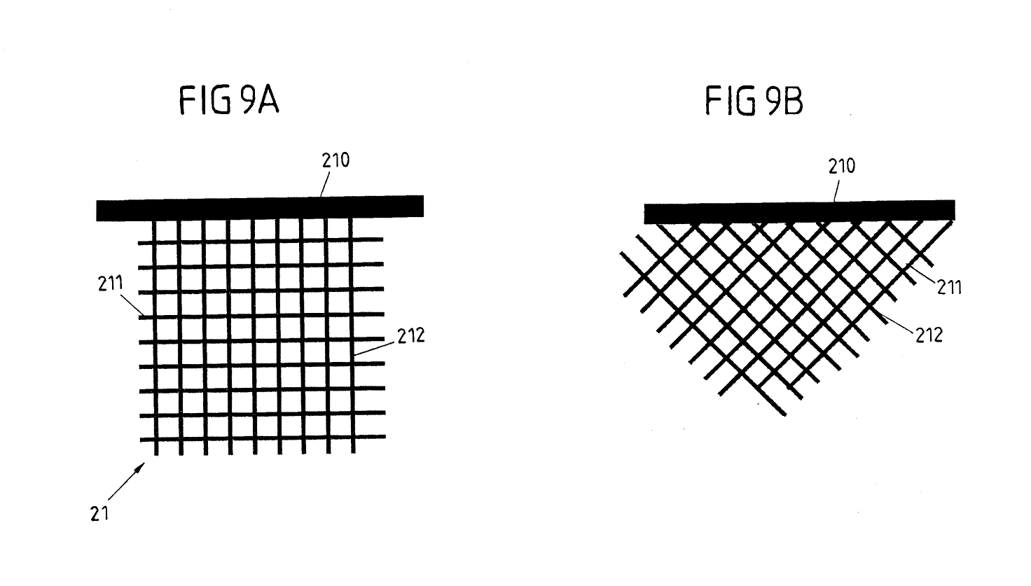

FIG. 9A relates to a further variant of the invention, wherein the side gas bag is formed of at least one fabric layer 21 which includes warp and weft threads 211, 212. The gas bag is mounted in the vehicle such that after inflating the gas bag the weft threads 212 extend substantially parallel to a roof rail 210. In the folded condition, the side gas bag extends in particular along the roof rail 220.

FIG. 9B shows a modification of the exemplary embodiment of FIG. 9A. Here, the side gas bag is arranged such that in the inflated gas bag the fabric layer 21 is oriented such that both the warp threads 211 and the weft threads extend obliquely relative to the roof rail 210, e.g. each at an angle of at least 10°.

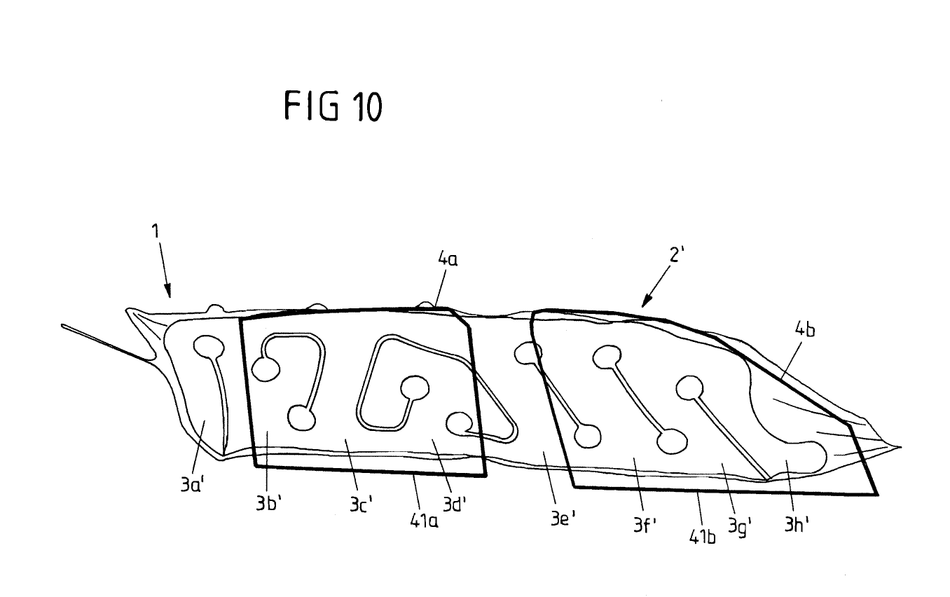

FIG. 10 shows a side gas bag arrangement 1 according to an exemplary embodiment of the second aspect of the invention. Accordingly, the side gas bag 2′ of the side gas bag arrangement in turn includes a plurality of chambers 3a′-3h′, none of which however protrudes beyond the door sill 41a, 41b towards the vehicle floor. Except for the chamber 3b′, however, all chambers of the side gas bag 2′ are oriented obliquely to the vehicle height direction (with respect to the inflated condition of the side gas bag shown in FIG. 10), in order to obtain a stability of the gas bag as good as possible.

The side gas bag 2′ shown in FIG. 10 includes at least one chamber which, as described e.g. with reference to FIGS. 1 to 3, is sealed, in order to realize a rather long useful life of the inflated gas bag. Furthermore, the gas bag 2′ includes a front stabilizing chamber 3h′, whose function has also been described above.

It should be noted that elements of the exemplary embodiments explained with reference to the Figures can of course also be used in combination with each other. For example, the arrangement of the gas bag as shown in FIG. 9A or 9B can be realized with the gas bag arrangements of the remaining Figures.

1. A side gas bag arrangement for a vehicle occupant restraint system of a motor vehicle, comprising
at least one side gas bag inflatable for the protection of a vehicle occupant, which with a side gas bag arrangement mounted in the vehicle and in the inflated condition of the side gas bag extends along a long side of the vehicle, wherein
the side gas bag includes at least one inflatable chamber which is formed such that in the inflated condition of the side gas bag it extends over a side window of the vehicle and in direction of the vehicle floor beyond a door sill adjoining the side window; and
sealing means which at least seal a partial region of the side gas bag, so that gas is prevented from flowing out of this partial region to the outside.

2. The side gas bag arrangement according to claim 1, wherein the side gas bag is formed of at least two gas bag layers which are connected with each other by a seam which is at least partly sealed by a sealing material of the sealing means.

3. The side gas bag arrangement according to claim 1, wherein the sealing means comprise a sealing coating on an inner side of the partial region.

4. The side gas bag arrangement according to claim 1, wherein the chamber—as seen in longitudinal direction of the vehicle—extends in a middle region of a front side window or in a rear region of a rear side window.

5. The side gas bag arrangement according to claim 1, wherein at least one inflatable chamber of the side gas bag, in particular the chamber extending beyond the door sill, extends obliquely to the vehicle height direction.

6. The side gas bag arrangement according to claim 1, further comprising a plurality of fixing structures by which the side gas bag can be fixed on a vehicle structure, wherein the side gas bag is to be arranged in the vehicle such and the fixing structures are arranged such that they each lie on a common line with an impact region specified unambiguously in dependence on the size of the side window of the vehicle, onto which the vehicle occupant will impact in an accident with increased probability, which line extends parallel to the vehicle height direction.

7. The side gas bag arrangement according to claim 1, further comprising at least one inflatable stabilizing chamber, which prevents the vehicle occupant from moving out of the vehicle, as well as throttling means for throttling an inflow of gas into the stabilizing chamber.

8. The side gas bag arrangement according to claim 7, wherein the throttling means comprise an opening or a channel of the side gas bag, which has a smaller flow cross-section than an upstream portion of the side gas bag adjoining the opening or the channel.

9. The side gas bag arrangement according to claim 8, wherein the side gas bag is formed by two gas bag layers connected with each other via a circumferential connecting line and the opening or the channel extends between a portion of the connecting line and a further connecting region or between two connecting regions spaced from the circumferential connecting line.

10. The side gas bag arrangement according to claim 8, wherein the throttling means form a check valve which prevents gas from flowing back out of the stabilizing chamber.

11. The side gas bag arrangement according to claim 1, further comprising at least one catch element for stabilizing the inflated side gas bag, which with one end is fixed on a connecting region of the side gas bag, wherein the connecting region in the inflated side gas bag has a distance to an edge of the side gas bag.

12. The side gas bag arrangement according to claim 11, wherein the catch element is guided through at least one opening in the side gas bag.

13. The side gas bag arrangement according to claim 12, wherein the side gas bag has a plurality of openings through which the catch element is guided such that in the inflated condition of the side gas bag it alternately extends on a side of the side gas bag facing the vehicle side structure and on a side of the side gas bag facing away from the vehicle side structure.

14. The side gas bag arrangement according claim 1, the side gas bag is folded and/or rolled up along a direction which extends obliquely to its main deployment direction.

15. The side gas bag arrangement according to claim 1, wherein the side gas bag is formed of at least one fabric layer which includes a plurality of first threads and second threads which extend vertically to the first threads, wherein the side gas bag is to be arranged in the vehicle such that the first or second threads of the fabric layer—with respect to the condition of the side gas bag mounted in the vehicle and inflated—at least partly extend substantially parallel to a roof frame of the vehicle, or the first and second threads at least partly each include an angle of at least 10° with the roof frame.

16. The side gas bag arrangement, comprising
at least one side gas bag inflatable for the protection of a vehicle occupant, which with a side gas bag arrangement mounted in the vehicle and in the inflated condition of the side gas bag extends along a long side of the vehicle, wherein
the side gas bag includes at least one inflatable chamber which in the inflated condition of the side gas bag extends obliquely to the vehicle height direction; and
sealing means which at least seal a partial region of the side gas bag, so that gas is prevented from flowing out of this partial region to the outside.
